(19) United States
(12) Patent Application Publication
(10) Pub. No.: US 2023/0050205 A1
(43) Pub. Date: Feb. 16, 2023

(54) A Process for Waterless Standalone Power Generation

(71) Applicant: ASSURE THERMAL ENERGY SOLUTIONS LLP, Pune (IN)

(72) Inventors: Kailas NIMBALKAR, Pune (IN); Nilesh KAWOOR, Pune (IN); Ajay TELANG, Pune (IN)

(73) Assignee: Assure Thermal Energy Solutions, LLP, Pune (IN)

(21) Appl. No.: 17/793,992

(22) PCT Filed: Jan. 23, 2021
(86) PCT No.: PCT/IN2021/050072

§ 371 Date: Jul. 20, 2022

(30) Foreign Application Priority Data
Jan. 24, 2020 (IN) 202021003315

(51) Int. Cl. F02C 6/14; F02C 6/06; H02K 7/18

(52) U.S. Cl. CPC F02C 6/14; F02C 6/06; H02K 7/1823

(57) ABSTRACT

A process for waterless standalone power generation is disclosed that generates electricity efficiently using an ORC fluid which reduces emissions and water usage as compared to conventional power generation process. The waterless standalone power generation plant 100 includes a stabilizer 115, a condensing evaporator 120, a preheater 125, a recuperator 135, an integral chilling unit 140, a pair of condensers 145 and 175, an accumulator 160, a turbine 165, a generator 170. The condensing stabilizer 115 and evaporator 120 reduce the temperature of the flue gases to maintain it below working temperature of ORC fluid and trap the latent heat and the sensible heat which increases the efficiency of the waterless standalone power generation plant 100.

### FIELD OF THE INVENTION

The present invention relates to a waterless power generation process and more particularly to a waterless power generation process that converts heat into electricity using the Organic Rankine Cycle (ORC).

### BACKGROUND OF THE INVENTION

Electricity is most often generated by electromechanical generators, primarily driven by heat engines fueled by combustion of fossil fuels. This high temperature air, or thermal energy, is then used to heat a liquid power generation medium (typically water) in a boiler to create a gas (steam) that is expanded across a steam turbine that drives an electrical generator. Although quite widely used, this method of energy generation has various drawbacks as it contributes heavily to global warming and thermal emissions, use of non-renewable sources such as fossil fuels are and rising costs of fossil fuels.

U.S. Patent U.S. Pat. No. 4,212,160A discloses a combined cycle electric power generating plant having a steam generator and a gas turbine in which low BTU gas from a coal gasifier is the fuel. The drawback of this type of conventional power generating process is that they cause a lot of emissions and thermal pollution which results in global warming. Global warming is a major concern that is being faced by humanity and there have been many efforts to address the emissions problem by exploiting non-combustible energy sources, such as windmills, fuel cells, solar cells, closed cycle solar reflector/boilers, use of tidal motion and others.

U.S. Patent U.S. Pat. No. 4,262,484A discloses a gas turbine engine power plant using solar energy as a heat source. The drawback of this type of power plant is it is unable to sustain the energy requirements of a developing nation like India as the efficiency (15%) of such process is low compared to conventional power plants.

Enormous amounts of waste heat spilled, flows and fumes into ambient environment, contaminates our living surroundings, creating greenhouse effect. The said waste heat is expelled mostly at temperatures of 60-550° C. About 30%-65% of the heat produced by burning of organic fuels is lost as a waste heat. Various attempts have been made to utilize this waste heat. Most notably Organic Rankine Cycle (ORC) process is used to utilize this waste heat. The major drawback of existing ORC process is they utilize flue gas temperatures only up to 110° C. to 120° C. which severely reduces the efficiency of the process.

There is a need of a power generation process that can reduce emissions whilst sustaining the energy requirements using ORC fluid. Further there is a need of a power generation process that reduces the use of water.

### SUMMARY OF THE INVENTION

A process for waterless standalone power generation has bio-degradable raw materials that are incinerated inside a combustion chamber to about 900° C.-1000° C. The non-biodegradable raw materials are incinerated inside a pyrolysis chamber. The flue gases received from either combustion chamber or the pyrolysis chamber are stabilized by diluting atmospheric air. The heat from the hot flue gases is exchanged with the compressed air from an air compressor inside a heat exchanger. An organic rankine fluid is preheated inside the preheater. The organic rankine fluid inside the condensing evaporator is vaporized by utilizing the heat from the flue gases. The vaporized organic rankine fluid is accumulated inside an accumulator to spin the turbine. The excess vapor received from the turbine is recaptured inside the recuperator. The vaporized ORC flue gases are condensed again into the fluid form inside the condenser. The organic rankine fluid is stored inside the receiver tank. The organic rankine fluid is pumped towards the condensing evaporator through a pump.

The pyrolysis chamber receives flue gases for incinerating plastic and rubber to produce oil. The pyrolysis chamber incinerates raw materials at about 450° C.-500° C. The turbine generates about 10 kW-200 kW of electricity. The heat exchanger having a turbine connected, to generate 10 kW-100 kW of electricity by flowing hot flue gases towards the turbine. The condensing evaporator having pluralities of baffle plates, pluralities of pipes and an external casing. The baffle plates positioned on the external surface of the pluralities of pipes having pluralities of perforations for cleaning the dust deposited thereon. The baffle plates reciprocate along the length of pluralities of pipes through reversing screw.

The organic rankine fluid flows through the inlet of pluralities of pipes to produce vapors by exchanging heat from the hot flue gases. The organic rankine fluid used is R245fa or Dichloromethane (CH₂Cl₂). The acid neutralizer or cold water is passed through the inlet of pluralities of pipes cleaning the pipes from inside. The acid neutralizer used for cleaning is Sodium Hydroxide (NaOH).

### BRIEF DESCRIPTION OF DRAWINGS

The objectives and advantages of the present invention will become apparent from the following description read in accordance with the accompanying drawings wherein:

FIG. 1 shows various elements of the waterless standalone power generation plant in accordance with a preferred embodiment of the present invention;

FIG. 2 is a perspective view of the condensing evaporator of the waterless standalone power generation plant of FIG. 1;

FIG. 2a is a back view of the condensing evaporator of the waterless standalone power generation plant of FIG. 1; and

FIG. 2b is front view of the condensing evaporator of the waterless standalone power generation plant of FIG. 1.

### DETAILED DESCRIPTION OF THE INVENTION

The invention described herein is explained using specific exemplary details for better understanding. However, the invention disclosed can be worked on by a person skilled in the art without the use of these specific details.

References in the specification to “one embodiment” or “an embodiment” means that particular feature, structure, characteristic, or function described in connection with the embodiment is included in at least one embodiment of the invention. The appearances of the phrase “in one embodiment” in various places in the specification are not necessarily all referring to the same embodiment.

References in the specification to “preferred embodiment” means that a particular feature, structure, characteristic, or function described in detail thereby omitting known constructions and functions for clear description of the present invention.

The foregoing description of specific embodiments of the present invention has been presented for purposes of illustration and description. They are not intended to be exhaustive or to limit the present invention to the precise forms disclosed, and obviously many modifications and variations are possible in light of the above teaching.

In general aspect, the present invention is a waterless standalone power generation plant 100 that uses Organic Rankine Cycle (ORC) to convert heat energy into electrical energy. The waterless standalone power generation plant 100 is designed in such a way that it utilizes the waste heat or direct heat (from the combustion of fuel) to generate electricity.

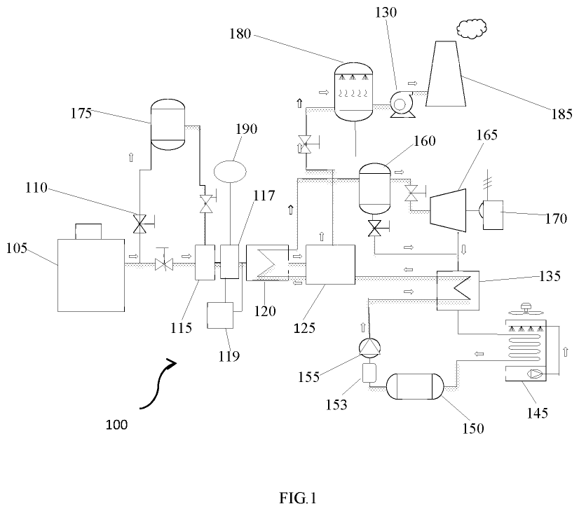

Referring to FIG. 1, the waterless standalone power generation plant 100 in accordance with a preferred embodiment of the present invention is described. The waterless standalone power generation plant 100 includes a combustion chamber 105, a plurality of valves 110, a stabilizer 115, a heat exchanger 117, a first turbine 119, a condensing evaporator 120, a preheater 125, an induced draft (ID) fan 130, a recuperator 135, a condenser 145, a receiving tank 150, a gas pressure pump 153, a pump 155, an accumulator 160, a turbine 165, a generator 170, a pyrolysis chamber 175, a water scrubber unit 180, a chimney 185 and an air compressor 190.

In the present invention the combustion chamber 105 incinerates the materials in an enclosed environment so that the hot flue gases are created within the combustion chamber 105. The pyrolysis chamber 175 has plastic to oil generator that receives hot flue gases from combustion chamber 105 to pyrolyse plastic and rubber waste and generates oil from said waste. The stabilizer 115 stabilizes flue gas temperature levels as per the requirement by diluting flue gases with ambient air. The air compressor 190 produces compressed air that is received by the heat exchanger 117.

The heat exchanger 117 exchanges heat from hot flue gases with the compressed air that is received in the turbine 119. The turbine 119 rotates by receiving hot compressed gases to generate electricity. However, the turbine 119 is smaller relative to the turbine 165. The preheater 125 preheats the organic rankine fluid. In the condensing evaporator 120 the organic rankine fluid is evaporated that produces sufficient amount of high pressure organic fluid vapors. The accumulator 160 ensures stable supply of high pressure organic fluid vapors to the turbine 165. In the turbine 165 the pressure energy from pressurized organic vapors is converted into the rotational energy. The generator 170 generates electrical energy from the rotational energy received through the turbine 165. In the present embodiment the electricity is generated by turbine 119 and turbine 165 however, the electricity generated through turbine 165 is significantly higher than that of turbine 119.

The recuperator 135 captures exhaust heat from the turbine 165. The condenser 145 condenses the exhaust organic fluid gases received from the recuperator 135. The receiving tank 150 stores organic rankine fluid. The gas pressure pump 153 creates pressure by utilizing exhaust vapor. The gas pressure pump 153 creates net positive suction force at the inlet of the pump 155. The pump 155 forces the organic rankine fluid towards the preheater 135. The water scrubber unit 180 sprays water into the exhaust flue gas to neutralize pollutants and capture contaminants. The flue gases are released into the atmosphere using the chimney 180 which receives the gases using the ID fan 130.

In accordance with the present invention, high temperature flue gases are developed in the combustion chamber 105. The valves 110 allow controlled flow of flue gases from combustion chamber 105 to the connected stabilizer 115 and the pyrolysis chamber 175 respectively through pipes. The stabilizer 115 is connected to the heat exchanger 117. The heat exchanger 117 is connected with the condensing evaporator 120, the air compressor 190 and the turbine 119. The condensing evaporator 120 is connected to the accumulator 160 and the preheater 125. The outlet of the accumulator 160 is connected to the turbine 165 which is connected to the generator 170. The accumulator 160 and turbine 165 are also connected to the recuperator 135. The recuperator 135 is connected to the preheater 125 and to the condenser 145.

The condenser 145 is connected to the recuperator 135 from one end and the receiver tank 150 from another end. The pump 155 is connected to the receiver tank 150 from one end and the gas pressure pump 153 from another end. The outlet of the recuperator 135 is connected to the preheater 125. The outlet of the preheater 125 is connected to the condensing evaporator 120 and the water scrubber unit 180. The combustion chamber 105 is also connected to the pyrolysis chamber 175. The outlet of the water scrubber unit 180 is attached to the ID fan 130 which is connected to the chimney 185.

Now referring to FIG. 1, a method of generating oil from the waterless standalone power generation plant 100 is described hereinafter. The combustion chamber 105 produces heat by incinerating raw materials. In context of the present invention the raw materials used are preferably bio-degradable waste materials however the raw materials may vary in other embodiments of the present invention. Further, the two way valve 110 connects the combustion chamber 105 with the pyrolysis chamber 175. The valve 110 is opened to pass the heat towards the pyrolysis chamber 175. Further, the pyrolysis chamber 175 receives tyre and plastic waste as input. In the present invention the pyrolysis chamber 175 is enclosed and preferably cylindrical shaped, however, the shape and size may vary in other embodiments of the present invention. The pyrolysis chamber 175 utilizes heat to pyrolysis the plastic and tyre waste by maintaining the temperature in the range of 450° C.-500° C. to convert the waste material into oil and gas at ambient pressure. Further, the oil is collected from the pyrolysis chamber 175 and the generated flue gas is transmitted towards the stabilizer 115. The stabilizer 115 dilutes the hot flue gases with the atmospheric air and channelizes the gas towards the heat exchanger 117.

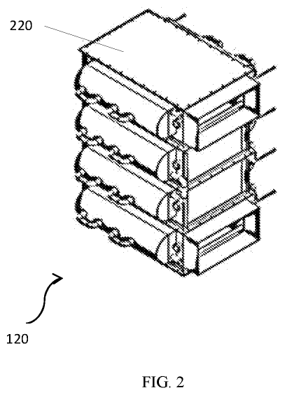

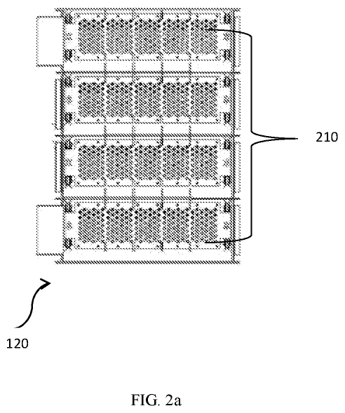

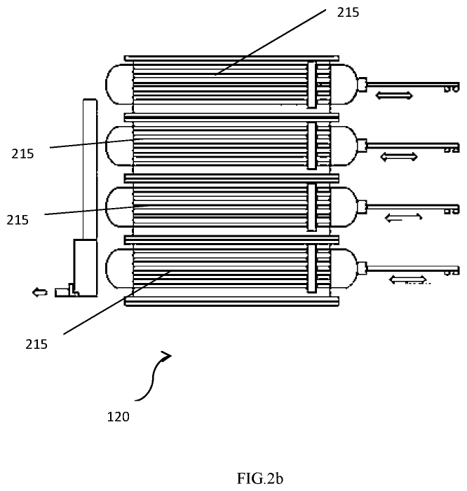

Referring to FIGS. 2-2b the condensing evaporator 120 of the process for waterless standalone power generation is described. The condensing evaporator 120 includes a plurality of baffle plates 210, a plurality of pipes 215 and an external casing 220. The condensing evaporator 120 is preferably rectangular in shape and is covered with external casing 220 to protect from external damage. The pluralities of pipes 215 are enclosed within the casing 220 where the pipes 215 are positioned parallel to one another in accordance with the present invention. The pluralities of pipes 215 are preferably hollow and allow passage of fluid through the pipes 215. The pluralities of pipes 215 are connected with the nearest pipe. The baffle plates 210 are positioned on the external surface of the pluralities of pipe 215. The baffle plates 210 are reciprocable over the external surface of the pipes 215 along the length of the pluralities of pipe 215. The reciprocating mechanism is provided to reciprocate the baffle plates 210 on the pluralities of pipes 215.

In context of the present invention the cleaning process of the condensing evaporator 120 is described hereinafter. The condensing evaporator 120 is connected to the heat exchanger 117 and the turbine 119 to receive hot flue gas. The hot flue gases are received and channelized over the pluralities of pipes 215. Simultaneously, cold fluid is passed through the inlet of the pipes 215 while the hot flue gases are flown into the condensing evaporator 120. In the present embodiment the cold water, acid neutralizer are utilized as cold fluids however, the fluid may change in other embodiments of the present invention. The cold fluid flowing through the pipes 215 receive the heat from the flue gases to reduce the temperature of the hot flue gases. The temperature of cold fluid increases as it exchanges heat from the flue gases hence, the heated fluid is then flushed from the output of pipes 215. Similarly, the reciprocating movement of the baffle plates 210 cleans any dust particles deposited on the surface of the pluralities of pipes 215.

In context of the present invention the organic rankine cycle fluid is passed through the inlet of pluralities of pipes 215. In context of the present invention the organic rankine cycle fluid is R245fa or Dichloromethane (CH2Cl2) however, the organic cycle fluid may vary in other embodiments of the present invention. The hot flue gases received from the heat exchanger 117 and the turbine 119 heat the pluralities of pipes 215. The flue gases evaporate the organic rankine cycle fluid present inside the pluralities of pipes 215. The vaporized organic rankine cycle is then passed towards the accumulator 160 for electricity generation. Similarly the hot flue gases are received by the preheater 125. In the present embodiment the organic rankine cycle fluid is flown from the inlet of pluralities of pipes 215 to generate electricity. Similarly, the cold water, acid neutralizer and the like are flown from the inlet of pluralities of pipes 215 to internally clean the pluralities of pipes 215. It is to be noted that either organic rankine fluid or acid neutralizers are flown into the pluralities of pipes 215 as per the user requirement.

Now referring to FIGS. 1-2b, a preferred process of the waterless standalone power generation plant 100 is described. High temperature flue gases are developed in the combustion chamber 105 by combustion of fuels like biomass, municipal solid waste, textile waste, gas or bio-degradable materials. The high temperature flue gases either enter the stabilizer 115 or enter the pyrolysis chamber 175. The flue gases enter into the pyrolysis chamber 175 through the valve 110. The hot flue gases heat the raw material inside the pyrolysis chamber 175 to about 450°-500° C. The oil produced by heating the raw material is collected from the pyrolysis chamber 175 separately whereas the flue gases enter the stabilizer 115.

The flue gases are passed to stabilizer 115 that are diluted with suitable quantity of atmospheric air to regulate and maintain the temperature and flow of the flue gases. The heat exchanger 117 receives hot flue gases from the stabilizer 115. Simultaneously, the heat exchanger 117 also receives the compressed air from the air compressor 190. The heat exchanger 117 channels the hot flue gases towards the turbine 119 and towards the condensing evaporator 120. The turbine 119 rotates by receiving the hot flue gases and generates electricity.

The turbine 119 also channels the waste exhaust flue gases towards the condensing evaporator 120. The ORC fluid is received by the condensing evaporator 120 using the pump 155. The ORC fluid is preheated using the preheater 125 before entering the condensing evaporator 120. The hot flue gases then enter the condensing evaporator 120 where the heat from the flue gases is used to evaporate the ORC fluid flowing through the pluralities of pipes 215.

In the condensing evaporator 120 the excess hot flue gases are flowed to the preheater 125 whereas the vapours formed by evaporating organic rankine cycle fluid are passed to the accumulator 160. The preheater 125 transmits the flue gases towards the water scrubber unit 180. The water scrubber unit 180 cools the temperature of flue gases about 40°-50° C. The water scrubber unit 180 sprays water into the exhaust flue gas to neutralize pollutants and capture contaminants. The flue gases are released into the atmosphere using the chimney 180 which receives the gases using the ID fan 130.

The hot vapours produced from evaporating ORC fluid inside the condensing evaporator 120 are stored in the accumulator 160 and then passed to the turbine 165. The accumulator 160 provides a stable amount of gas to the turbine 165. The ORC fluid gas pressure is used to create rotational mechanical energy in the turbine 165.

The rotational energy received from the turbine 165 is used to generate electricity in the generator 170. The excess vapours from the turbine are then passed to the recuperator 135 which recaptures the heat from the vapours. The vapours are then cooled down and are converted into liquid inside the condenser 145. The condensed ORC fluid is then recollected in the receiver tank 150. The receiver tank 150 stores the ORC fluid for the waterless standalone power generation plant 100.

In accordance of the present invention the flue gas exhaust are dust and carbon free which reduces global warming. The plant advantageously uses 15 good low-grade film plastics, papers, cardboard blend, rice husk, wood, logs, briquettes, pellets, and the like that are currently dumped in landfills. Water requirement of the plant is very low as compared to traditional power generation systems.

The present invention is further illustrated by following exemplary embodiments, which should not be construed as limiting the scope of the invention.

### EXAMPLES

### Example 1: Process for Generation of Electricity

Bio-degradable materials such as rice husk, wood, logs, briquettes, pellets of about 100 kg are incinerated inside the combustion chamber 120 at about 900° C.-1000° C. for approximately 60 minutes. The combustion chamber 120 produces 400 kg of flue gas by incinerating 100 kg of bio-degradable materials. Non-Biodegradable materials such as film plastics and rubber tyre of about 100 kg are pyrolysed inside pyrolysis chamber 175 at about 450° C.-500° C. for approximately 60 minutes. The pyrolysis chamber 175 produces 50 liters of oil from 100 kg pyrolysed plastic and rubber tyre. The pyrolysis chamber 175 re-forwards 400 kg of flue gases by pyrolyizing 100 kg of plastic and rubber. The generated oil is collected separately whereas the 400 kg flue gas is transmitted towards the stabilizer 115. The flue gases produced from the combustion chamber 120 and the pyrolysis chamber 175 are channelized towards the stabilizer 115.

The stabilizer 115 dilutes about 10%-20% ambient air of the total received hot flue gases. The stabilizer transmits the diluted flue gases towards the heat exchanger 117. The heat exchanger 117 heats up compressed air by flue gases through the air compressor 190 and channelizes the flue gases towards the condensing evaporator 120. The turbine 119 rotates by heated compressed air. The turbine 119 is connected with the electric generator to generate more than 10 kW of electricity. The turbine 119 transmits the exhaust flue gases towards the condensing evaporator 120. The condensing evaporator 120 receives hot flue gases from heat exchanger 117 and the turbine 119. Simultaneously, the pump 155 and gas pressure pump 153 uplifts the organic rankine fluid stored inside the receiver tank 150 towards the preheater 125. The receiver tank 150 stores up to 150 liters of R245fa or Dichloromethane (CH₂Cl₂) as an organic rankine cycle fluid.

The preheater 125 receives the organic rankine cycle fluid where the preheater preheats the organic rankine cycle fluid to about 90° C.-100° C. and channelizes towards the condensing evaporator 120. The condensing evaporator 120 simultaneously receives the hot flue gases and the organic rankine cycle fluid. In the condensing evaporator 120 the hot flue gases evaporate the organic rankine cycle fluid where the evaporated vapor is channelized towards the accumulator 160 and the hot flue gases are channelized towards the preheater 125.

The accumulator 160 provides stable amount of vapors of organic rankine fluid to the turbine 165. The turbine 165 rotates and generates around 20 kW of electricity through the generator 170. The turbine 165 channelizes excess heat towards the condenser 145 through the recuperator 135 for condensing the vapors of organic rankine fluid into the fluid. The fluid is then stored inside the receiver tank 150. Simultaneously, the preheater 125 channelizes the hot flue gases towards the water scrubber unit 180 where the temperature of flue gases is reduced to 40° C.-50° C. The flue gases are then channelized into atmosphere through the chimney 185 and ID fan 130.

The embodiments were chosen and described in order to best explain the principles of the present invention and its practical application, to thereby enable others, skilled in the art to best utilize the present invention and various embodiments with various modifications as are suited to the particular use contemplated.

It is understood that various omission and substitutions of equivalents are contemplated as circumstance may suggest or render expedient, but such are intended to cover the application or implementation without departing from the scope of the present invention.

1. A process for waterless standalone power generation 100, said process comprising the steps of:
a) incinerating bio-degradable raw materials inside a combustion chamber 105 at a temperature ranging from 900° C.-1000° C.;
b) incinerating non-biodegradable raw materials inside a pyrolysis chamber 175;
c) stabilizing the flue gases received from either combustion chamber 120 or the pyrolysis chamber 175 by diluting atmospheric air;
d) exchanging heat from the hot flue gases with the compressed air from an air compressor 190 inside a heat exchanger 117;
e) preheating an organic rankine fluid inside the preheater 125;
f) vaporizing the organic rankine fluid inside the condensing evaporator 120 by utilizing the heat from the flue gases;
g) accumulating vaporized organic rankine cycle inside an accumulator 160 to spin the turbine 165;
h) recapturing heat from the excess vapor received from the turbine 165 inside the recuperator 135;
i) condensing the vaporized ORC fluid gases into the fluid form inside the condenser 145;
j) storing the organic rankine fluid inside the receiver tank 150; and
k) pumping organic rankine fluid towards the condensing evaporator 120 through a pump 155.

2. The process for waterless standalone power generation as claimed in claim 1 wherein, the pyrolysis chamber 175 receives flue gases and incinerates plastic and rubber to produce oil.

3. The process for waterless standalone power generation as claimed in claim 1 wherein, the pyrolysis chamber 175 incinerates raw materials at a temperature ranging from about 450° C.-500° C.

4. The process for waterless standalone power generation as claimed in claim 1 wherein, the turbine 165 generates about 10 kW-200 kW of electricity.

5. The process for waterless standalone power generation as claimed in claim 1 wherein, the heat exchanger 117 having a turbine 119 connected generates about 10 kW-100 kW of electricity by flowing hot flue gases towards the turbine 119.

6. The process for waterless standalone power generation as claimed in claim 1 wherein, the condensing evaporator 120 has plurality of baffle plates 210, plurality of pipes 215 and an external casing 220.

7. The process for waterless standalone power generation as claimed in claim 6 wherein, the baffle plates 210 positioned on the external surface of the plurality of pipes 215 have plurality of perforations for cleaning the dust deposited thereon.

8. The process for waterless standalone power generation as claimed in claim 6 wherein, the baffle plates 210 reciprocate along the length of plurality of pipes 215 through reversing screw.

9. The process of waterless standalone power generation as claimed in claim 6 wherein, the organic rankine fluid flows through the inlet of plurality of pipes 215 to produce vapors by exchanging heat from the hot flue gases.

10. The process of waterless standalone power generation as claimed in claim 6 wherein, the organic rankine fluid flowing through the pluralities of pipes 215 is R245fa or Dichloromethane (CH₂Cl₂).

11. The process of waterless standalone power generation as claimed in claim 6 wherein, an acid neutralizer or cold water is passed through the inlet of plurality of pipes 215 for cleaning the pipes 215 from inside.

12. The process of waterless standalone power generation as claimed in claim 11 wherein, the acid neutralizer used for cleaning is Sodium Hydroxide (NaOH).
